(19) United States
(12) Patent Application Publication
(10) Pub. No.: US 2013/0038543 A1
(43) Pub. Date: Feb. 14, 2013

(54) Touch Sensor Panel

(71) Applicant: Sheng-Chung SU, Chiayi City (TW)

(72) Inventor: Sheng-Chung SU, Chiayi City (TW)

(73) Assignee: CHUNGHWA PICTURE TUBES, LTD., Taoyuan (TW)

(21) Appl. No.: 13/334,475

(22) Filed: Dec. 22, 2011

(30) Foreign Application Priority Data
Aug. 9, 2011 (TW) 100128369

(51) Int. Cl. G06F 3/041

(52) U.S. Cl. 345/173

(57) ABSTRACT

A touch sensor panel comprises a substrate, a plurality of parallel first sensing bars, a plurality of parallel second sensing bars and an insulating layer. The first and second sensing bars are disposed above the substrate, and the insulating layer is disposed between the first and second sensing bars. Each of the first sensing bars includes a plurality of first routes. Each of the first routes has a pair of opposite first side edges, and at least one of the first routes has an opening disposed between the first side edges. Each of the second sensing bars includes a plurality of second routes. Each of the second routes overlaps with one of the first routes. At least one overlapping zone is formed between the first route having the opening and the second route, and the overlapping zone is disposed between the opening and the first side edges.

### CROSS-REFERENCE TO RELATED APPLICATION

This application claims the benefit of Taiwan Patent Application No. 100128369, filed on Aug. 9, 2011, which is hereby incorporated by reference for all purposes as if fully set forth herein.

### FIELD OF DISCLOSURE

The present disclosure relates to a touch input device and more particularly to a touch sensor panel (TSP).

### RELATED ART

Nowadays in the touch sensor panel industry, many manufacturers of touch sensor panels (TSPs) are devoting their efforts to improve the quality of the TSP in order to enhance the competitiveness of products. For instance, some manufacturers perform research on the sensitivity of current touch sensor panels, and endeavor to develop touch sensor panels with higher sensitivity. Therefore, many manufacturers emphasize the importance of enhancing the sensitivity of current touch sensor panels.

### SUMMARY OF THE DISCLOSURE

A touch sensor panel of the present disclosure can reduce the value of parasitic capacitance or stray capacitance in order to maintain or enhance the sensitivity.

A touch sensor panel of the present disclosure comprises a substrate, a plurality of first sensing bars, a plurality of second sensing bars and an insulating layer. The substrate has a flat surface. The first sensing bars are disposed above the flat surface and are parallel to each other. Each of the first sensing bars includes a plurality of first sensing electrodes and a plurality of first routes. Each of the first routes is connected between two adjacent first sensing electrodes and has a pair of opposite first side edges. The first side edges are connected to the first sensing electrodes, and at least one of the first routes further has an opening disposed among the first side edges. The second sensing bars are disposed above the flat surface and are parallel to each other. Each of the second sensing bars includes a plurality of second sensing electrodes and a plurality of second routes. Each of the second routes is connected between two adjacent second sensing electrodes. The first sensing bars intersect with the second sensing bars. Each of the second routes overlaps with one of the first routes. At least one overlapping zone is formed between the first route with the opening and the second route, and the overlapping zone is disposed between the opening and one of the first side edges. The insulating layer is disposed between the first sensing bars and the second sensing bars, and covers the flat surface.

Based on the abovementioned, the overlapping area between the first routes and the second routes is reduced by employing the openings of the first routes, so that the value of parasitic capacitance is reduced. Therefore, the sensitivity of touch sensor panels can be maintained or enhanced.

The present disclosure will become more fully understood by reference to the following detailed description thereof when read in conjunction with the attached drawings.

### BRIEF DESCRIPTION OF THE DRAWINGS

FIG. 1A is a planform view of a touch sensor panel according to the first embodiment of the present disclosure;

FIG. 1B is a cross-sectional view along line I-I of FIG. 1A;

FIG. 1C is a partial enlarged view of FIG. 1A;

FIG. 1D is a cross-sectional view along line II-II of FIG. 1C;

FIG. 2A is a planform view of a touch sensor panel according to the second embodiment of the present disclosure;

FIG. 2B is a cross-sectional view along line III-III of FIG. 2A;

FIG. 3A is a planform view of a touch sensor panel according to the third embodiment of the present disclosure;

FIG. 3B is a cross-sectional view along line IV-IV of FIG. 3A;

FIG. 3C is a partial enlarged view of FIG. 3A;

FIG. 3D is a cross-sectional view along line V-V of FIG. 3C;

FIG. 4A is a planform view of a touch sensor panel according to the fourth embodiment of the present disclosure; and

FIG. 4B is a cross-sectional view along line VI-VI of FIG. 4A.

### DETAILED DESCRIPTION OF THE DISCLOSURE

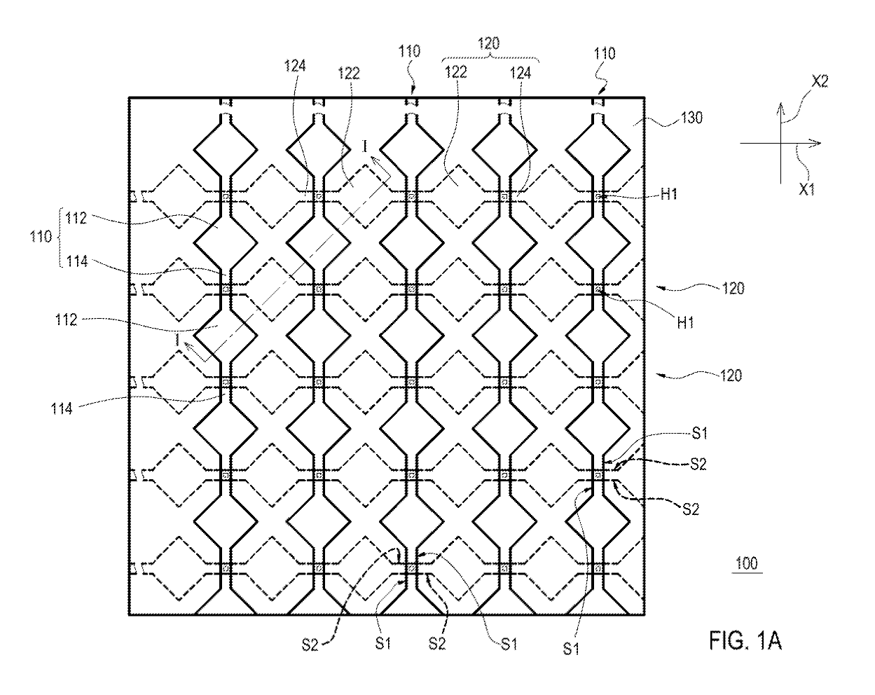

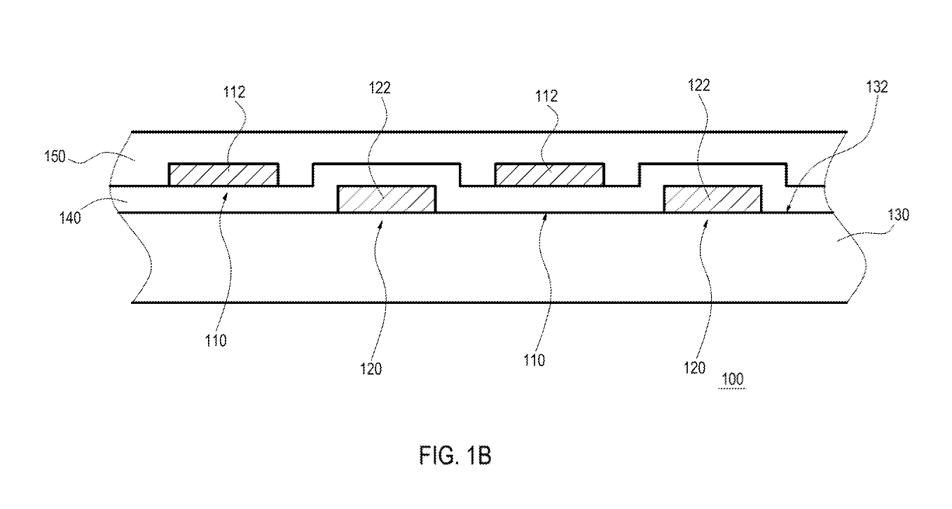

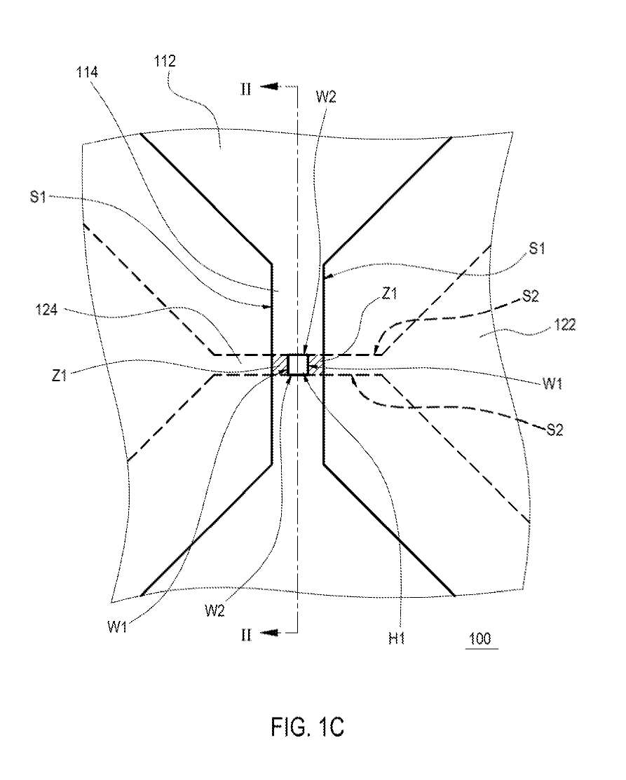

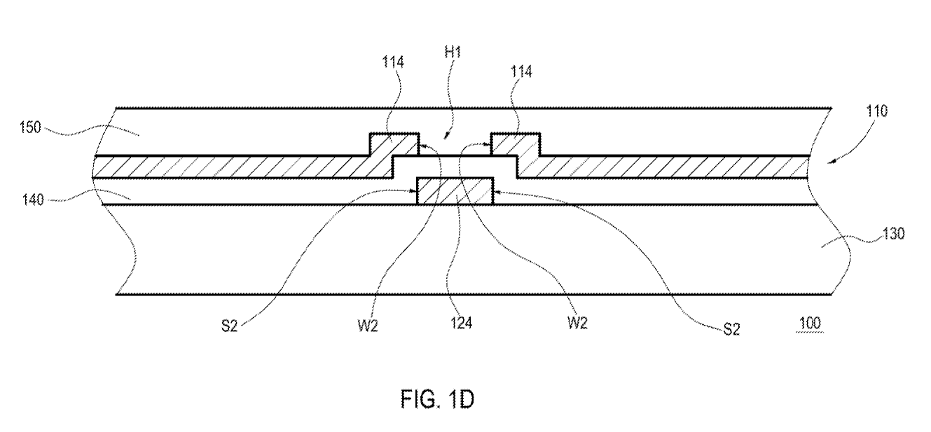

FIG. 1A shows a planform view of a touch sensor panel according to the first embodiment of the present disclosure, and FIG. 1B is a cross-sectional view along line I-I of FIG. 1A of a touch sensor panel of the present disclosure. Referring to FIGS. 1A and 1B, a touch sensor panel 100 in this embodiment can be used for manufacturing the touch screens of various electronic devices such as tablet personal computers, notebook computers, smart mobile phones and arcade games, etc.

The touch sensor panel 100 comprises a plurality of first sensing bars 110, a plurality of second sensing bars 120, a substrate 130 and an insulating layer 140. The substrate 130 can be a transparent substrate such as a glass flate or a sapphire substrate. The substrate 130 has a flat surface 132. The first sensing bars 110, the second sensing bars 120 and the insulating layer 140 are disposed above the flat surface 132. Therefore, the first sensing bars 110, the second sensing bars 120 and the insulating layer 140 are on the same side of the substrate 130.

The second sensing bars 120 are disposed below the first sensing bars 110 and they are in contact with the flat surface 132. The insulating layer 140 is disposed between the first sensing bars 110 and the second sensing bars 120, and covers the flat surface 132 and the second sensing bars 120. Therefore, the second sensing bars 120 are disposed between the substrate 130 and the insulating layer 140. Furthermore, the insulating layer 140 can be made of insulation materials such as silicon oxide (SiOₓ) or silicon nitride (SiNₓ), and the insulating layer 140 can be transparent.

The first sensing bars 110 are parallel to each other, and the second sensing bars 120 are also parallel to each other. The first sensing bars 110 interlace with the second sensing bars 120; therefore, the arrangement directions of the first sensing bars 110 and the second sensing bars 120 are different. As shown in FIG. 1A, the arrangement directions of the first sensing bars 110 are perpendicular to those of the second sensing bars 120. As clearly shown in a planform view of the touch sensor panel 100 (FIG. 1A), the extending directions of the first sensing bars 110 are perpendicular to those of the second sensing bars 120.

In the embodiment shown in FIG. 1A, the extending directions of the second sensing bars 120 can be horizontal directions X1, and the extending directions of the first sensing bars 110 can be vertical directions X2. Nevertheless, in other embodiments, the extending directions of the second sensing bars 120 can be vertical directions X2, and the extending directions of the first sensing bars 110 can be horizontal directions X1. Therefore, the extending directions of the first sensing bars 110 and the second sensing bars 120 shown in FIG. 1A are not a limitation of the present disclosure.

The structures of the first sensing bars 110 and the second sensing bars 120 are similar. More specifically, each of the first sensing bars 110 includes a plurality of first sensing electrodes 112 and a plurality of first routes 114; each of the second sensing bars 120 includes a plurality of second sensing electrodes 122 and a plurality of second routes 124. Furthermore, the first sensing electrodes 112 and the first routes 114 of the same first sensing bar 110 are arranged in a same row along the vertical direction X2, and the second sensing electrodes 122 and the second routes 124 of the same second sensing bar 120 are arranged in a same row along the horizontal direction X1.

Each of the first routes 114 is connected between the two adjacent first sensing electrodes 112, and each of the second routes 124 is connected between the two adjacent second sensing electrodes 122. More specifically, each of the first routes 114 has a pair of opposite first side edges S1, and the first side edges S1 are connected to the first sensing electrodes 112. Each of the second routes 124 has a pair of opposite second side edges S2, and the second side edges S2 are connected to the second sensing electrodes 122.

Since the first sensing bars 110 interlace with the second sensing bars 120, the first sensing bars 110 overlap partially with the second sensing bars 120. More specifically, as shown in FIG. 1A, each of the second routes 124 overlaps with one of the first routes 114; therefore, the second routes 124 correspond to the first routes 114. However, each of the second sensing electrodes 122 does not overlap with any one of the first sensing electrodes 112, as shown in FIG. 1A.

In addition, the touch sensor panel 100 can also comprise a protective layer 150. The protective layer 150 covers the first sensing bars 110 and the insulating layer 140 entirely for protecting the first sensing bars 110. The protective layer 150 can be made of the same material used for the insulating layer 140. For examples, the protective layer 150 can be made of insulation materials such as silicon oxide (SiOₓ) or silicon nitride (SiNₓ), and the protective layer 150 can be transparent.

It is necessary to mention that, the protective layer 150 is an optional element of the present disclosure and is not an indispensable element. Therefore, in other embodiments, the touch sensor panel 100 does not have to include any protective layer 150. Additionally, the touch sensor panel 100 shown in FIG. 1A is drawn without showing the protective layer 150, therefore the first sensing bars 110 shown in FIG. 1A are drawn with solid lines.

When the touch sensor panel 100 is used, users can use a touch pen or a finger to control the touch sensor panel 100. When a touch pen or a finger is in contact with the protective layer 150, or the insulating layer 140 and the first sensing bars 110; the capacitance values of the first sensing bars 110 and the second sensing bars 120 corresponding to the touch pen or finger will change. According to the changed capacitance values, electronic devices can then be controlled by the touch sensor panel 100, for example to move a cursor shown on the screen panel. Thus, users can use the touch sensor panel 100 to control electronic devices.

Since the touch sensor panel 100 can be used to manufacture touch screens, both of the first sensing electrodes 112 and the second sensing electrodes 122 can be transparent conductive layers, and both of the first routes 114 and the second routes 124 can be transparent conductive lines. Both of the transparent conductive layers and the transparent conductive lines are made of materials such as indium tin oxide (ITO) or indium zinc oxide (IZO).

However, it is necessary to mention that, even though the touch sensor panel 100 is used for manufacturing touch screens, the first routes 114 and the second routes 124 is not required to be transparent conductive lines when the display quality is not affected. For instance, all the first routes 114 and the second routes 124 can be metal lines; or some of the first routes 114 and some of the second routes 124 are metal lines, and the rest of the first routes 114 and the second routes 124 are transparent conductive lines.

Furthermore, it is worth a mention that, the touch sensor panel 100 not only can be used for manufacturing touch screens, but also can be used for manufacturing non-transparent touch input devices such as electronic sketch pads or touch pads of notebook computers. Therefore, the substrate 130 can also be a non-transparent substrate, and the first sensing electrodes 112 and the second sensing electrodes 122 can be metal layers.

In this embodiment, each of the first routes 114 has an opening H1, and the second routes 124 are disposed under the openings H1. In the same first route 114, the openings H1 are disposed between the first side edges S1. The openings H1 are in closed shapes when being looked down from the top (as shown in FIG. 1A); the openings H1 can be rectangular as shown in FIG. 1A. Therefore, the walls of the openings H1 are not connected to any one of the first side edges S1, in other words, the openings H1 are not extended from any one of the first side edges S1.

It is necessary to mention that, although each of the first routes 114 has an opening H1 as shown in FIG. 1A in this embodiment, in other embodiments, only one of the first routes 114 or at least two of the first routes 114 have the opening H1, and the rest of the first routes 114 do not have any opening H1. Therefore, the amount and distribution of the openings H1 shown in FIG. 1A are only for description as an example, but not as a limitation of the present disclosure.

FIG. 1C is a partial enlarged view of FIG. 1A, and FIG. 1D is a cross-sectional view along line II-II of FIG. 1C of a touch sensor panel of the present disclosure. FIG. 1C shows an enlarged view of the overlapping zones between the first routes 114 and the second routes 124. Referring to FIGS. 1C and 1D, at least one overlapping zone Z1 (as indicated by a zone with oblique lines in FIG. 1C) is formed between the first route 114 and the second route 124. FIG. 1C is taken as an example, the number of the overlapping zones Z1 is two, i.e. there are two overlapping zones Z1 formed between the first route 114 and the second route 124, and each of the two overlapping zones Z1 is disposed between the opening H1 and one of the first side edges S1.

The opening H1 has a pair of first opening walls W1 and a pair of second opening walls W2. In the same opening H1, the pair of first opening walls W1 is connected to the pair of second opening walls W2, wherein the pair of first opening walls W1 is disposed between the pair of second opening walls W2. The arrangement directions of the first opening walls W1 can be the same to those of the first side edges S1; and the arrangement directions of the second opening walls W2 can be the same to those of the second side edges S2.

The second side edges S2 of the second routes 124 disposed below the openings H1 are substantially aligned with the second opening walls W2. More specifically, when one of the openings H1 is viewed from the top, it is shown in FIG. 1C that the second side edges S2 basically overlap with the second opening walls W2. Therefore, the second route 124 basically only overlaps with a part of the first route 114 between the opening H1 and the first side edges S1; and the overlapping zone Z1 is limited between the two second side edges S2 of the second route 124.

Since each of the second routes 124 overlaps with one of the first routes 114, it is unavoidable that parasitic capacitance will be produced in the overlapping areas between the first routes 114 and the second routes 124. The parasitic capacitance will attenuate the electric signals, and thus reduce the sensitivity of the touch sensor panel 100. The larger the parasitic capacitance value, the larger is the degree of reduction of sensitivity.

However, since the second routes 124 are disposed under the openings H1, the openings H1 can reduce the overlapping areas between the first routes 114 and the second routes 124, so as to reduce the parasitic capacitance value. Thus, the attenuation of electric signals is reduced, so that the sensitivity of the touch sensor panel 100 can be maintained or enhanced. Furthermore, the overlapping zones Z1 are limited between the two second side edges S2 of the second routes 124, therefore the overlapping areas between the first routes 114 and the second routes 124 can be effectively reduced in order to enhance the sensitivity.

Additionally, the openings H1 can be designed freely. For example, the area of the openings H1 can be enlarged so as to maintain effective line widths of the first routes 114 and the second routes 124, and the second side edges S2 substantially are still aligned with the second opening walls W2. Therefore, without further changing the resistances of the first routes 114 and the second routes 124, in this embodiment the overlapping areas between the first routes 114 and the second routes 124 can be still reduced in order to maintain or enhance the sensitivity of the touch sensor panel 100.

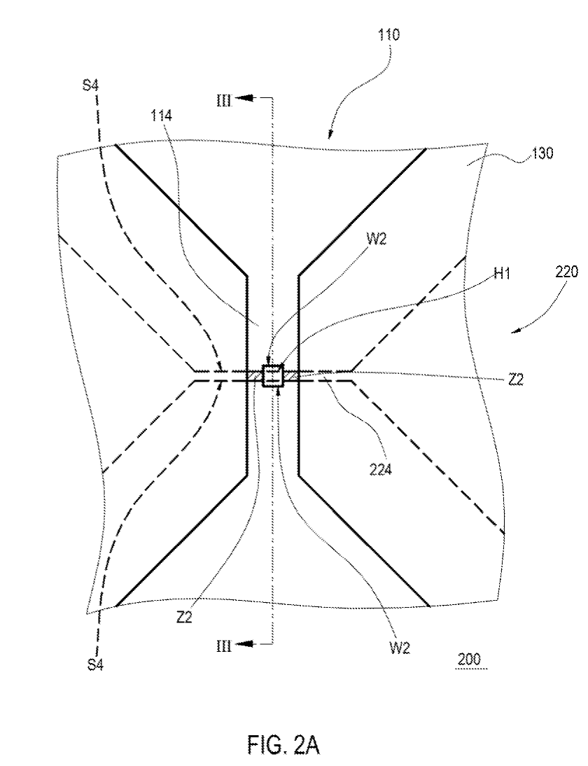

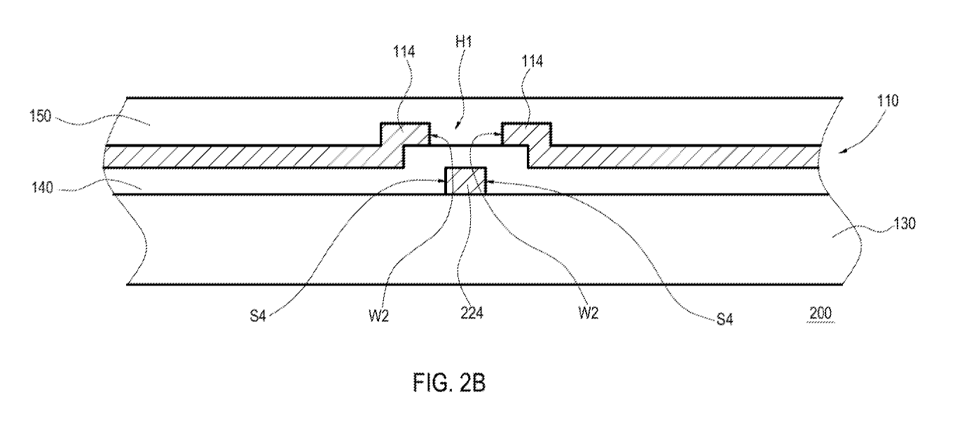

FIG. 2A is a planform view of a touch sensor panel according to the second embodiment of the present disclosure, and FIG. 2B is a cross-sectional view along line III-III of FIG. 2A of a touch sensor panel of the present disclosure. Referring to FIGS. 2A and 2B, a touch sensor panel 200 is structurally similar to the touch sensor panel 100.

For example, the touch sensor panel 100 and the touch sensor panel 200 have some of the same elements, which are the first sensing bars 110, the substrate 130, the insulating layer 140 and the protective layer 150. Furthermore, the advantages, functions and applications of the touch sensor panel 200 and the touch sensor panel 100 are basically the same; therefore they will not be repeated again.

The touch sensor panel 200 comprises a plurality of second sensing bars 220; and the difference between the touch sensor panel 200 and the touch sensor panel 100 is related to a second route 224 of each of the second sensing bars 220. More specifically, in the touch sensor panel 200, each of the second routes 224 has a pair of opposite second side edges S4; and the second side edges S4 of the same second route 224 are disposed between the two second opening walls W2 of the opening H1 as shown in FIG. 2A.

Therefore, at least one overlapping zone Z2 (as indicated by a zone with oblique lines in FIG. 2A) is formed between the first route 114 and the second route 224; and the overlapping zone Z2 is limited between the two second side edges S4 of the second route 224. Therefore, the overlapping areas between the first routes 114 and the second routes 224 are reduced, whereby the sensitivity of the touch sensor panel 200 can be effectively enhanced.

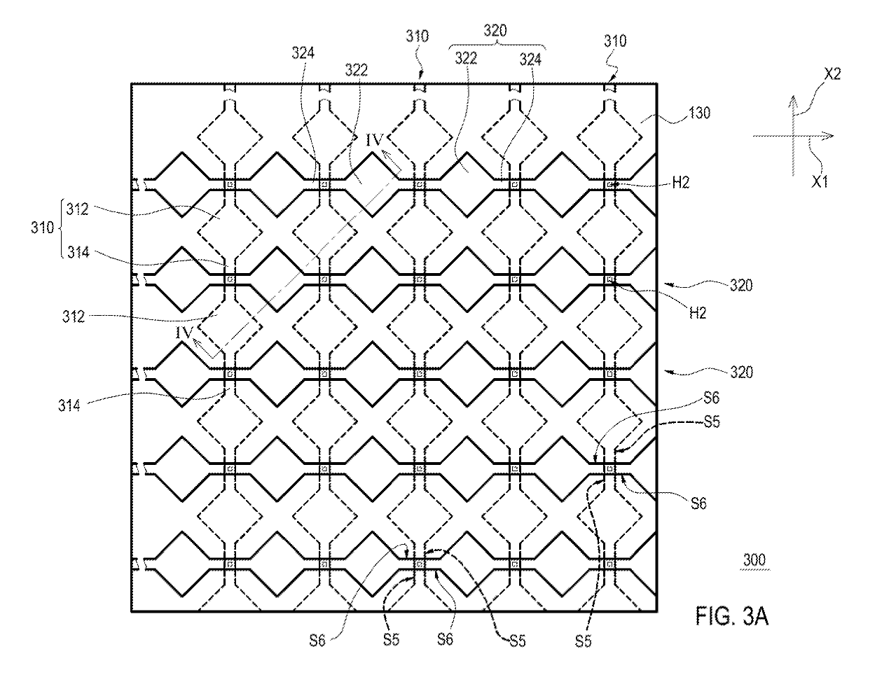

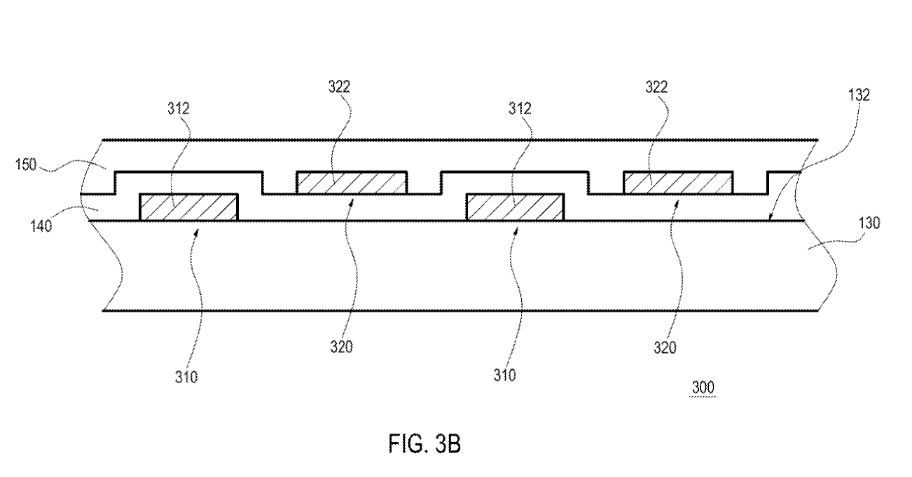

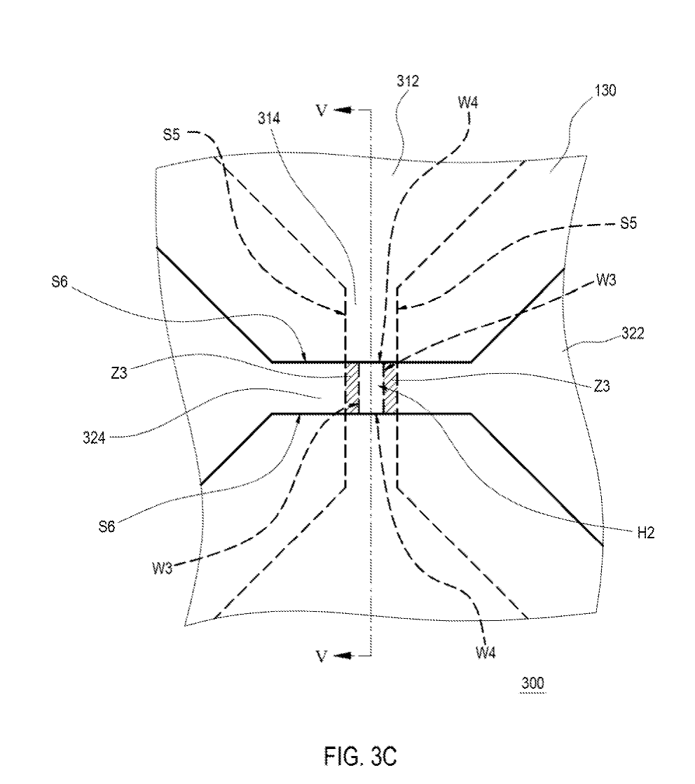

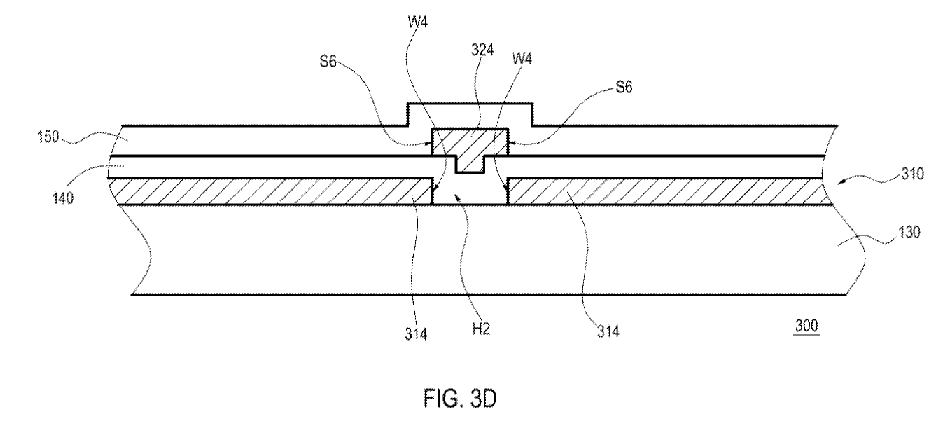

FIG. 3A is a planform view of a touch sensor panel according to the third embodiment of the present disclosure, and FIG. 3B is a cross-sectional view along line Iv-Iv of FIG. 3A of a touch sensor panel of the present disclosure. Referring to FIGS. 3A and 3B, a touch sensor panel 300 in this embodiment comprises a plurality of first sensing bars 310, a plurality of second sensing bars 320, the substrate 130, the insulating layer 140 and the protective layer 150. The touch sensor panel 300 is structurally similar to the touch sensor panel 100, the only differences between the touch sensor panel 300, 100 are: the locations of the first sensing bars 310 are differently from those of the first sensing bars 110, and the locations of the second sensing bars 320 are differently from those of the second sensing bars 120.

More specifically, the first sensing bars 310, the second sensing bars 320 and the insulating layer 140 are disposed above the flat surface 132 of the substrate 130. However, distinguishing from the touch sensor panel 100; the first sensing bars 310 are in contact with the flat surface 132, and the insulating layer 140 covers the first sensing bars 310 and the flat surface 132. The second sensing bars 320 are disposed on the insulating layer 140 and above the first sensing bars 310. Therefore, the insulating layer 140 is disposed between the first sensing bars 310 and the second sensing bars 320, and the first sensing bars 310 are disposed between the insulating layer 140 and the substrate 130.

The first sensing bars 310 and the second sensing bars 320 are interlaced with each other. As shown in FIG. 3A, the arrangement directions of the first sensing bars 310 are substantially perpendicular to those of the second sensing bars 320. The extending directions of the second sensing bars 320 are horizontal directions X1, and the extending directions of the first sensing bars 310 are vertical directions X2. Nevertheless, in other embodiments, the extending directions of the second sensing bars 320 can be the vertical directions X2, and the extending directions of the first sensing bars 310 can be the horizontal directions X1. Therefore, the extending directions of the first sensing bars 310 and the second sensing bars 320 shown in FIG. 3A are not a limitation of the present disclosure thereof.

Each of the first sensing bars 310 includes a plurality of first sensing electrodes 312 and a plurality of first routes 314; each of the first routes 314 is connected between two adjacent first sensing electrodes 312. More specifically, each of the first routes 314 has a pair of opposite first side edges S5, and the first side edges S5 are connected to the first sensing electrodes 312. Furthermore, the material of the first sensing electrodes 312 can be the same material of the aforementioned first sensing electrodes 112, and the material of the first routes 314 can be the same material of the aforementioned first routes 114.

Each of the second sensing bars 320 includes a plurality of second sensing electrodes 322 and a plurality of second routes 324; each of the second routes 324 is connected between two adjacent second sensing electrodes 322. More specifically, each of the second routes 324 has a pair of opposite second side edges S6, and the second side edges S6 are connected to the second sensing electrodes 322. Furthermore, the material of the second sensing electrodes 322 can be the same material of the aforementioned second sensing electrodes 122, and the material of the second routes 324 can be the same material of the aforementioned second routes 124.

The first sensing bars 310 overlap partially with the second sensing bars 320. More specifically, as shown in FIG. 3A, each of the second routes 324 overlaps with one of the first routes 314; therefore, the second routes 324 correspond to the first routes 314. However, each of the second sensing electrodes 322 does not overlap with any one of the first sensing electrodes 312, as shown in FIG. 3A.

Furthermore, each of the first routes 314 has an opening H2, and the second routes 324 are disposed over the openings H2. In the same first route 314, the openings H2 are disposed between the first side edges S5, and the walls of the openings H2 are not connected to any one of the first side edges S5; in other words, the openings H2 are not extended from any one of the first side edges S5.

It is necessary to mention that, although each of the first routes 314 has an opening H2 as shown in FIG. 3A in this embodiment; in other embodiments, only one or at least two of the first routes 314 have the opening H2, and the rest of the first routes 314 do not have any opening H2. Therefore, the amount and distribution of the openings H2 shown in FIG. 3A are only for description as an example, but not as a limitation of the present disclosure thereof.

FIG. 3C is a partial enlarged view of FIG. 3A, and FIG. 3D is a cross-sectional view along line V-V of FIG. 3C of a touch sensor panel of the present disclosure. FIG. 3C shows an enlarged view of the overlapping zones between the first routes 314 and the second routes 324. Referring to FIGS. 3C and 3D, at least one overlapping zone Z3 (as indicated by a zone with oblique lines in FIG. 3C) is formed between the first route 314 and the second route 324. FIG. 3C is taken as an example, there are two overlapping zones Z3 formed between the first route 314 and the second route 324, and each of the two overlapping zones Z3 is disposed between the opening H2 and one of the first side edges S5.

The opening H2 has a pair of first opening walls W3 and a pair of second opening walls W4. In the same opening H2, the pair of the first opening walls W3 is connected to the pair of the second opening walls W4, in other words, the pair of first opening walls W3 is disposed between the pair of second opening walls W4. The arrangement directions of the first opening walls W3 can be the same to those of the first side edges S5; and the arrangement directions of the second opening walls W4 can be the same to those of the second side edges S6.

The second side edges S6 of the second routes 324 disposed above the openings H2 are substantially aligned with the second opening walls W4. Therefore, the second route 324 basically only overlaps with the part of the first route 314 between the opening H2 and the first side edges S5; and the overlapping zone Z3 is limited between the two second side edges S6 of the second route 324. Thus, the overlapping areas between the first routes 314 and the second routes 324 are reduced.

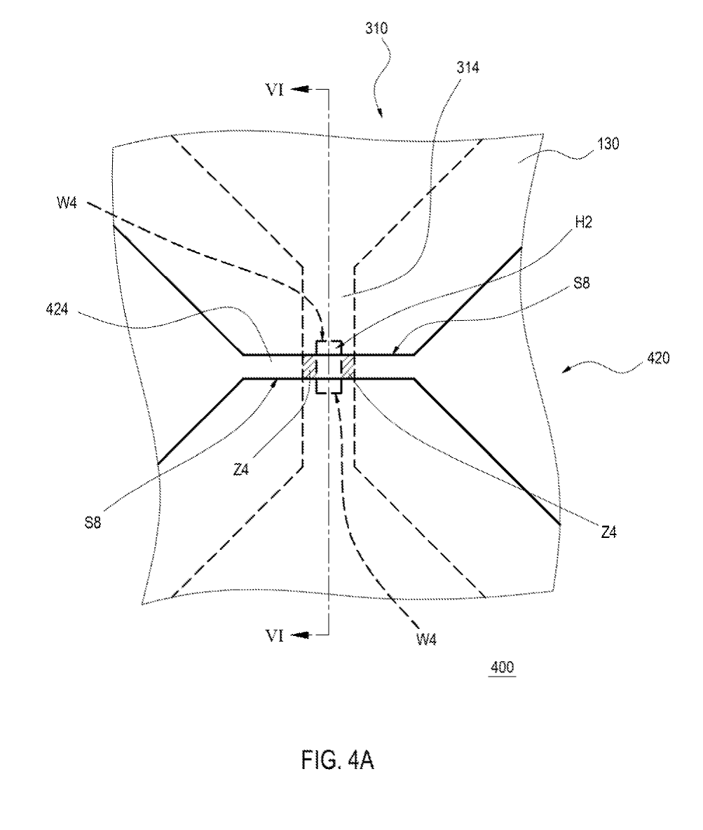

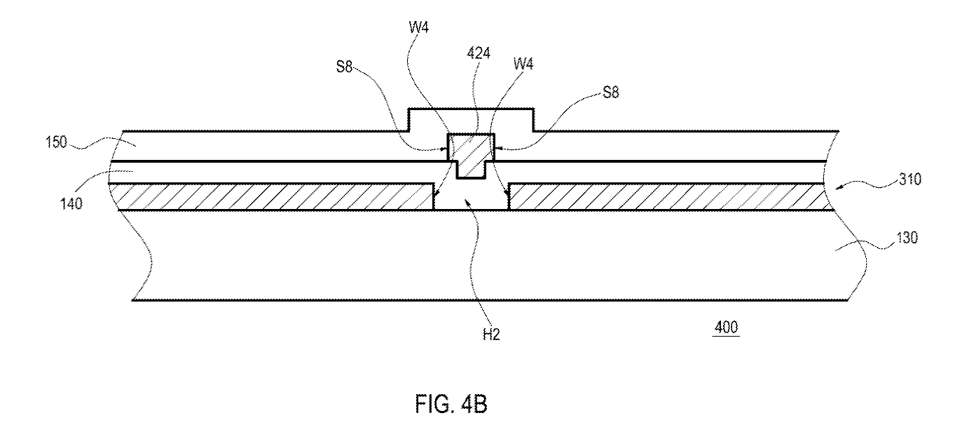

Although in this embodiment, the second side edges S6 are substantially aligned with the second opening walls W4; in another embodiment, the second side edges S6 of the same second route 324 can be disposed between the two second opening walls W4 of the opening H2 as shown in a touch sensor panel 400 in FIGS. 4A and 4B.

FIG. 4A is a planform view of a touch sensor panel according to the fourth embodiment of the present disclosure, and FIG. 4B is a cross-sectional view along line VI-VI of FIG. 4A of a touch sensor panel of the present disclosure. Referring to FIGS. 4A and 4B, the touch sensor panel 400 is structurally similar to the touch sensor panel 300; for examples, the touch sensor panel 400 comprises a plurality of the first sensing bars 310, the substrate 130, the insulating layer 140 and the protective layer 150. The difference between the touch sensor panel 400 and the touch sensor panel 300 is related to second routes 424 of the touch sensor panel 400.

The touch sensor panel 400 comprises a plurality of second sensing bars 420, and each of the second sensing bars 420 has a plurality of second routes 424. Each of the second routes 424 has a pair of opposite second side edges S8; and the second side edges S8 of the same second route 424 are disposed between the two second opening walls W4 of the opening H2. Each of the second routes 424 overlaps with one of the first routes 314 to form an overlapping zone Z4 (as indicated by a zone with oblique lines in FIG. 4A).

Since the second side edges S8 of the same second route 424 are disposed between the two second opening walls W4 of the opening H2, the overlapping zones Z4 are limited between the two second side edges S8 of the second routes 424. Therefore, the overlapping areas between the first routes 314 and the second routes 424 can be effectively reduced. Furthermore, it is necessary to mention that, the advantages, functions and applications of the touch sensor panels 300 and 400 are basically the same to those of the touch sensor panel 100; therefore they will not be repeated again.

As a conclusion from the abovementioned, in a touch sensor panel of the present disclosure, the openings of the first routes can reduce the overlapping areas between the first routes and the second routes, in order to reduce the parasitic capacitance value. Thus, the present disclosure can reduce the attenuation of electric signals, so as to maintain or enhance the sensitivity of touch sensor panels.

Note that the specifications relating to the above embodiments should be construed as exemplary rather than as limitative of the present disclosure, with many variations and modifications being readily attainable by a person of average skill in the art without departing from the spirit or scope thereof as defined by the appended claims and their legal equivalents.

What is claimed is:

1. A touch sensor panel comprising:
a substrate having a flat surface;
a plurality of first sensing bars disposed above the flat surface and being parallel to each other, wherein each of the first sensing bars comprises a plurality of first sensing electrodes and a plurality of first routes, each of the first routes is connected between the two adjacent first sensing electrodes and has a pair of opposite first side edges, the first side edges are connected to the first sensing electrodes, and at least one of the first routes also has an opening disposing between the first side edges;
a plurality of second sensing bars disposed above the flat surface and being parallel to each other, wherein each of the second sensing bars comprises a plurality of second sensing electrodes and a plurality of second routes, each of the second routes is connected between the two adjacent second sensing electrodes, the first sensing bars interlace with the second sensing bars, each of the second routes overlaps with one of the first routes, an overlapping zone is formed between the first route having the opening and the second route, and the overlapping zone is disposed between the opening and one of the first side edges; and
an insulating layer disposed between the first sensing bars and the second sensing bars, and covering the flat surface.

2. The touch sensor panel as claimed in claim 1, wherein the number of the overlapping zones is two, and each of the overlapping zones is disposed between the opening and one of the first side edges.

3. The touch sensor panel as claimed in claim 1, wherein each of the second routes has a pair of opposite second side edges, the second side edges are connected to the second sensing electrodes, the opening has a pair of first opening walls and a pair of second opening walls, the first opening walls are connected between the second opening walls, arrangement directions of the first opening walls are the same to those of the first side edges, and the second side edges of one of the second routes are substantially aligned with the second opening walls.

4. The touch sensor panel as claimed in claim 1, wherein each of the second routes has a pair of opposite second side edges, the second side edges are connected to the second sensing electrodes, the opening has a pair of first opening walls and a pair of second opening walls, the first opening walls are connected between the second opening walls, arrangement directions of the first opening walls are the same to those of the first side edges, and all of the second side edges of one of the second routes are disposed between the second opening walls.

5. The touch sensor panel as claimed in claim 1, wherein arrangement directions of the first sensing bars are substantially perpendicular to those of the second sensing bars.

6. The touch sensor panel as claimed in claim 1, wherein the first sensing bars are in contact with the flat surface and are disposed between the substrate and the insulating layer, and at least one of the second routes is disposed over the opening.

7. The touch sensor panel as claimed in claim 1, wherein the second sensing bars are in contact with the flat surface and are disposed between the substrate and the insulating layer, and at least one of the second routes is disposed right below the opening.

8. The touch sensor panel as claimed in claim 1, wherein the first sensing electrodes and the second sensing electrodes are a plurality of metal layers.

9. The touch sensor panel as claimed in claim 1, wherein the first sensing electrodes and the second sensing electrodes are a plurality of transparent conductive layers.

10. The touch sensor panel as claimed in claim 1, wherein the first routes and the second routes are a plurality of metal lines or a plurality of transparent conductive lines.
